(19) United States
(12) Patent Application Publication
(10) Pub. No.: US 2018/0103250 A1
(43) Pub. Date: Apr. 12, 2018

(54) DISPLAY DEVICE, INSPECTION METHOD, AND INSPECTION PROGRAM

(71) Applicant: FANUC CORPORATION, Yamanashi (JP)

(72) Inventor: Kazuki SAKAMOTO, Yamanashi (JP)

(21) Appl. No.: 15/710,158

(22) Filed: Sep. 20, 2017

(30) Foreign Application Priority Data
Oct. 6, 2016 (JP) 2016-198059

(51) Int. Cl. H04N 17/00; G06F 3/041; H04N 17/02

(52) U.S. Cl. CPC H04N 17/004; H04N 17/02; G06F 3/041

(57) ABSTRACT

To provide a display device, an inspection method, and an inspection program achieving detection of a degree of deterioration of each area in a touch panel. A numerical controller comprises: a detection unit that detects a touch position on a display at a given frequency; a setting unit that sets an expectation of the number of detections by the detection unit in each of the small areas resulting from division of the display in response to a speed of movement of the touch position; a determination unit that determines a degree of deterioration of each of the small areas by comparing the number of detections by the detection unit with one or more thresholds determined based on the expectation; and an output unit that outputs the degree of deterioration.

This application is based on and claims the benefit of priority from Japanese Patent Application No. 2016-198059, filed on 6 Oct. 2016, the content of which is incorporated herein by reference.

### BACKGROUND OF THE INVENTION

### Field of the Invention

The present invention relates to a display device with a touch panel, a method of inspecting the touch panel, and an inspection program.

### Related Art

A touch panel has conventionally been used as an input device superimposed on a display (display unit). Various known detection types are employed for touch panels such as a resistive type, a capacitive type, and an ultrasonic type. The resistive type, for example, has a long history and is used in many cases due to its inexpensiveness. The resistive-type touch panel is formed of two substrates with transparent electrodes (glass substrates or film substrates) arranged to face each other. Pressing the touch panel makes the substrates come into contact with each other. If the substrates contact each other, circuits on the substrates are operated to detect coordinates.

The above-described various types of touch panels have been desired to accurately recognize touch operation by a user. This desire may be met by a technique suggested in patent document 1, for example. This technique is to inspect a touch panel for abnormalities by detecting an unintended input to the touch panel occurring when software is started at the time of power-on. Patent document 2 suggests a technique of reducing deterioration of a touch panel by moving a button to coordinates in a sensitive area that has not been pressed frequently.

Patent Document 1: Japanese Unexamined Patent Application, Publication No. 2009-176162

Patent Document 2: Japanese Unexamined Patent Application, Publication No. 2007-72536

### SUMMARY OF THE INVENTION

In a touch panel employing the above-described resistive type, for example, the resistive value of a substrate changes with time or depending on the environment of use, reducing the sensitivity of the touch panel. The other detection types are also subject to sensitivity reduction with time or depending on environment of use, to deteriorate touch panels more seriously. Such touch panels have widely been used in numerical controllers (CNC devices) incorporated in machine tools. Reduction in the sensitivity of a touch panel greatly affects operability of an operator of a numerical controller, reducing production efficiency. Hence, a state of deterioration of the touch panel has been desired to be sensed in advance before the deterioration hinders operation by the operator.

The present invention is intended to provide a display device, an inspection method, and an inspection program achieving detection of a degree of deterioration of each area in a touch panel.

(1) A display device (numerical controller 1 described later, for example) according to the present invention comprises: a detection unit (detection unit 111 described later, for example) that detects a touch position on a display unit (display 701 described later, for example) at a given frequency; a setting unit (setting unit 112 described later, for example) that sets an expectation of the number of detections by the detection unit in each of the small areas resulting from division of the display unit in response to a speed of movement of the touch position; a determination unit (determination unit 113 described later, for example) that determines a degree of deterioration of each of the small areas by comparing the number of detections by the detection unit with one or more thresholds determined based on the expectation; and an output unit (output unit 114 described later, for example) that outputs the degree of deterioration.

(2) The display device described in (1) may comprise a guidance unit (guidance unit 115 described later, for example) that provides a guidance display for letting the small areas be touched continuously in a given order.

(3) In the display device described in (2), the guidance unit may provide a display for moving between the small areas at a predetermined constant speed.

(4) The display device described in any one of (1) to (3) may comprise a calculation unit (calculation unit 116 described later, for example) that calculates the speed of movement based on the touch position detected continuously and time intervals between the detections.

(5) In the display device described in any one of (1) to (4), the output unit may color-code each of the small areas in response to the degree of deterioration based on a result of the determination by the determination unit.

(6) An inspection method according to the present invention is to be executed by a computer. The method comprises: a detecting step of detecting a touch position on a display unit at a given frequency; a setting step of setting an expectation of the number of detections by the detecting step in each of the small areas resulting from division of the display unit in response to a speed of movement of the touch position; a determining step of determining a degree of deterioration of each of the small areas by comparing the number of detections by the detecting step with one or more thresholds determined based on the expectation; and an outputting step of outputting the degree of deterioration.

(7) An inspection program according to the present invention causes a computer to execute: a detecting step of detecting a touch position on a display unit at a given frequency; a setting step of setting an expectation of the number of detections by the detecting step in each of the small areas resulting from division of the display unit in response to a speed of movement of the touch position; a determining step of determining a degree of deterioration of each of the small areas by comparing the number of detections by the detecting step with one or more thresholds determined based on the expectation; and an outputting step of outputting the degree of deterioration.

According to the present invention, a degree of detection of each area in a touch panel is detected.

### BRIEF DESCRIPTION OF THE DRAWINGS

FIG. 1 is a block diagram showing the hardware configuration of a principal part of a numerical controller;

FIG. 2 is a block diagram showing the functional configuration of a CPU of the numerical controller;

FIG. 3 shows exemplary small areas in a display;

FIG. 4 shows exemplary thresholds for the number of detections and exemplary display colors;

FIG. 5A is a first view showing an exemplary screen display according to a method of inspecting a touch panel;

FIG. 5B is a second view showing an exemplary screen display according to the method of inspecting the touch panel;

FIG. 6 is a flowchart showing processing by the CPU;

FIG. 7A is a first view showing an exemplary variation of a guidance display;

FIG. 7B is a second view showing an exemplary variation of the guidance display; and

FIG. 8 shows an exemplary screen display without a guidance display.

### DETAILED DESCRIPTION OF THE INVENTION

An example of an embodiment of the present invention will be described below. In this embodiment, a numerical controller 1 is described as an example of a display device. However, the display device is not limited to the numerical controller 1 but it means every type of an information processor (computer) with a touch panel superimposed on a display (display unit). Examples of the display device include servers, PCs, mobile terminals, game machines, home appliances, navigation systems, and various types of controllers.

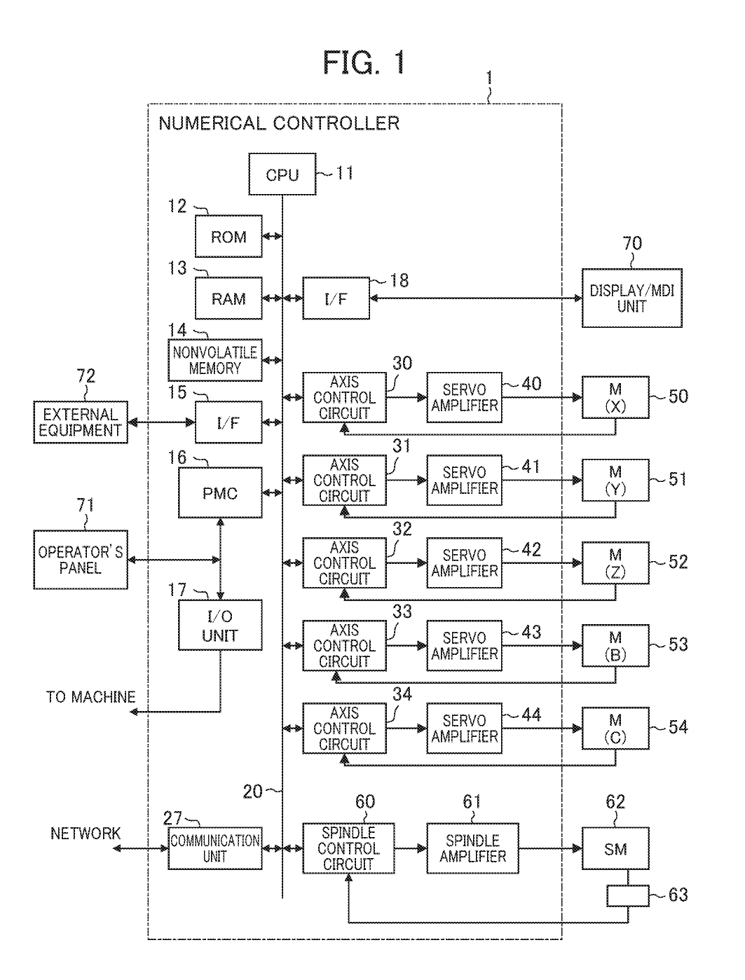

FIG. 1 is a block diagram showing the hardware configuration of a principal part of the numerical controller 1. The numerical controller 1 includes a CPU 11 as a processor that controls the entire numerical controller 1. The CPU 11 reads a system program stored in a ROM 12 through a bus 20 and controls the entire numerical controller 1 by following the read system program. A RAM 13 stores temporary calculated data, display data, and various types of data input by an operator through a display/MDI unit 70. Generally, access is made faster to a RAM than to a ROM. Thus, the CPU 11 may deploy the system program stored in the ROM 12 in advance on the RAM 13. Then, the CPU 11 may read the system program from the RAM 13 and execute the read system program. A nonvolatile memory 14 is a magnetic storage unit, a flash memory, an MRAM, FRAM, or an EEPROM, for example. Alternatively, the nonvolatile memory 14 is an SRAM or a DRAM backed up by a battery, for example. The nonvolatile memory 14 is configured as a nonvolatile memory to hold its storage state even after the numerical controller 1 is powered off. The nonvolatile memory 14 stores a machining program, etc. input through an interface 15, the display/MDI unit 70, or a communication unit 27.

The ROM 12 stores various system programs written in advance for executing processing in an edit mode required for generation and editing of a machining program and for executing processing for automatic operation. Various machining programs are input through the interface 15, the display/MDI unit 70, or the communication unit 27, and are stored into the nonvolatile memory 14. The interface 15 connects between the numerical controller 1 and external equipment 72. A machining program, various parameters, etc., are read from the external equipment 72 into the numerical controller 1. The machining program edited in the numerical controller 1 can be stored into an external storage through the external equipment 72. Specific examples of the interface 15 include an RS232C interface, a USB, an SATA interface, a PC card slot, a CF card slot, an SD card slot, Ethernet, and Wi-Fi. The interface 15 can be located on the display/MDI unit 70. Examples of the external equipment 72 include a computer, a USB memory, a CFast card, a CF card, and an SD card.

A programmable machine controller (PMC) 16 outputs a signal through an I/O unit 17 to an auxiliary device (such as an automatic tool change device) of a machine tool to control the auxiliary device by following a sequence program provided in the numerical controller 1. The PMC 16 accepts signals input through various switches, etc. of an operator's panel 71 arranged at the body of the machine tool, executes necessary signal processing, and transfers the processed signals to the CPU 11. Generally, the PMC 16 is also called a programmable logic controller (PLC). The operator's panel 71 is connected to the PMC 16. The operator's panel 71 may include a manual pulse generator, for example. The display/MDI unit 70 is a manual data input unit with a display 701 (display unit) and an operation unit such as a keyboard or a touch panel 702. An interface 18 is used for transmitting screen data to be displayed to the display 701 of the display/MDI unit 70. The interface 18 is also used for receiving a command and data from the operation unit of the display/MDI unit 70 and transferring the received command and data to the CPU 11.

Axis control circuits 30 to 34 of corresponding axes receive movement command amounts of the corresponding axes given from the CPU 11, and output the commands on the corresponding axes to servo amplifiers 40 to 44 respectively. In response to receipt of these commands, the servo amplifiers 40 to 44 drive servo motors 50 to 54 of the corresponding axes respectively. The servo motors 50 to 54 of the corresponding axes each include a built-in position and speed detector. The servo motors 50 to 54 transmit position and speed feedback signals as feedbacks to the axis control circuits 30 to 34 respectively, thereby exerting position and speed feedback control.

A spindle control circuit 60 outputs a spindle speed signal to a spindle amplifier 61 in response to receipt of a spindle rotation command directed to the machine tool. In response to receipt of the spindle speed signal, the spindle amplifier 61 rotates a spindle motor 62 of the machine tool at a rotation speed designated by the command, thereby driving a tool. A pulse encoder 63 is coupled to the spindle motor 62 with a gear or a belt, for example. The pulse encoder 63 outputs a feedback pulse in synchronization with the rotation of a spindle. The feedback pulse passes through the bus 20 to be read by the CPU 11.

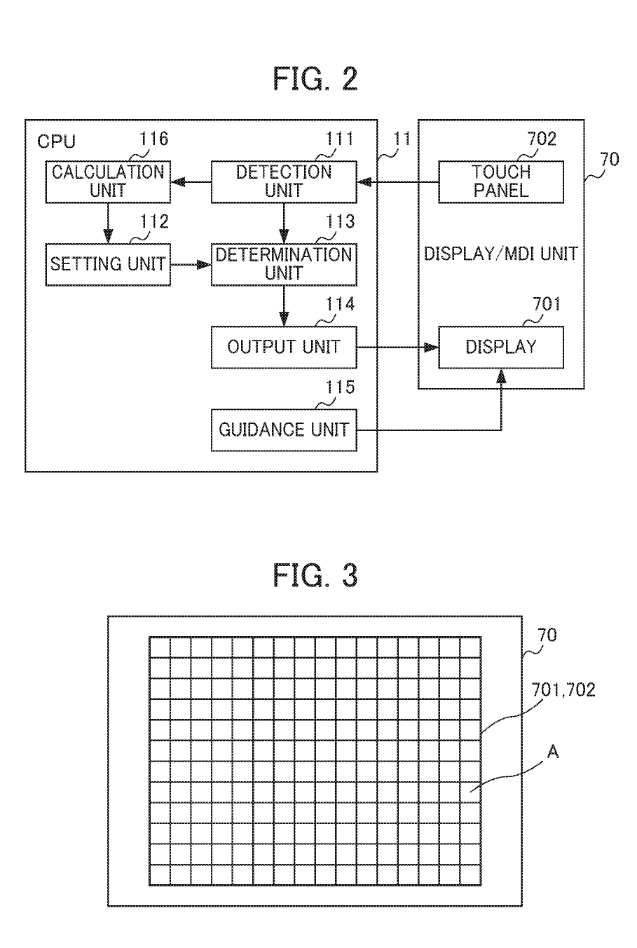

FIG. 2 is a block diagram showing the functional configuration of the CPU 11 of the numerical controller 1. The CPU 11 includes a detection unit 111, a setting unit 112, a determination unit 113, an output unit 114, a guidance unit 115, and a calculation unit 116. Each of these functional units is realized by execution of the system program in the ROM 12 by the CPU 11.

The detection unit 111 detects a touch position (coordinates) on the touch panel 702 superimposed on the display 701 at a given frequency.

The setting unit 112 sets an expectation of the number of detections by the detection unit 111 in each of the small areas resulting from division of the display 701 in response to a speed of movement of the touch position. If the detection unit 111 detects a touch position at a fixed frequency of 3000 Hz, and if one small area is touched continuously for 0.1 seconds, for example, an expectation of the number of detections is 300 about the touch panel 702 without deterioration. If the touch panel 702 is deteriorated more seriously, the number of detections falls short of this expectation and becomes smaller.

FIG. 3 shows exemplary small areas in the display 701. In the display/MDI unit 70, the display 701 on which the touch panel 702 is superimposed is divided into multiple small areas A in a matrix pattern (lattice pattern), for example. The numerical controller 1 may display the matrix on a screen of the display 701 and accept an input for designating a size of the small areas. The shape of the small areas is not limited to a square but it may be a rectangle or a different polygon. Meanwhile, the small areas preferably cover an entire detectable area in the touch panel 702.

The determination unit 113 determines a degree of deterioration of the small area by comparing the number of detections by the detection unit 111 in each small area with one or more thresholds determined based on an expectation set by the setting unit 112.

The output unit 114 outputs a degree of detection of each small area in the touch panel 702 determined by the determination unit 113. At this time, the output unit 114 notifies an operator of a degree of deterioration of each small area by color-coding each small area with a color in response to the degree of deterioration based on a result of the determination by the determination unit 113.

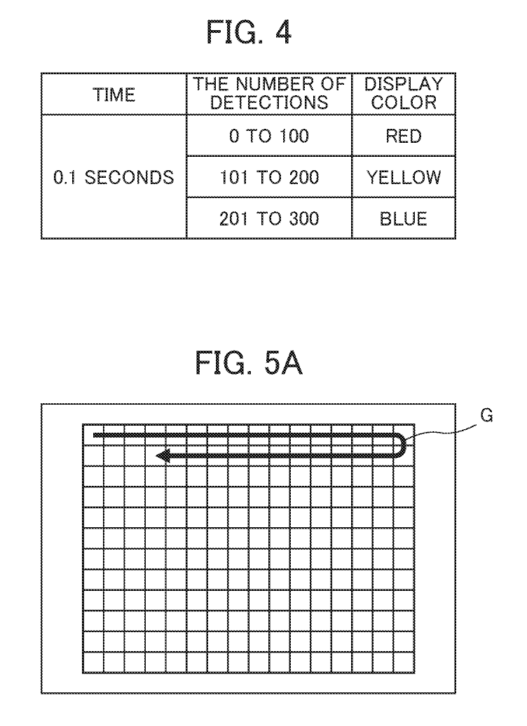

FIG. 4 shows exemplary thresholds for the number of detections and exemplary display colors. If the detection unit 111 detects a touch position at a fixed frequency of 3000 Hz, and if all of the small areas are touched sequentially while each of these small areas are touched continuously for 0.1 seconds, for example, an expectation of the number of detections in each small area is “300.” Based on this expectation, thresholds “200” and “100” are set. In this example, a small area with the number of detections “201 to 300” is given a blue color indicating no deterioration, or a low degree of deterioration. If the number of detections is reduced to “101 to 200” or “0 to 100,” a small area is given a yellow color or a red color in response to a degree of deterioration.

One or multiple thresholds are settable based on an expectation. The setting unit 112 may receive a threshold as a fixed value. Alternatively, the setting unit 112 may set a threshold by obtaining a given ratio to an expectation.

The guidance unit 115 provides a guidance display for letting the small areas be touched continuously in a given order. At this time, the guidance unit 115 provides a display for moving between the small areas at a predetermined constant speed. For example, the guidance unit 115 moves an object such as a figure to become a guidance at a speed of 10 frames per second. The operator follows this guidance display to continue touching all the small areas sequentially while staying at each of these small areas for 0.1 seconds.

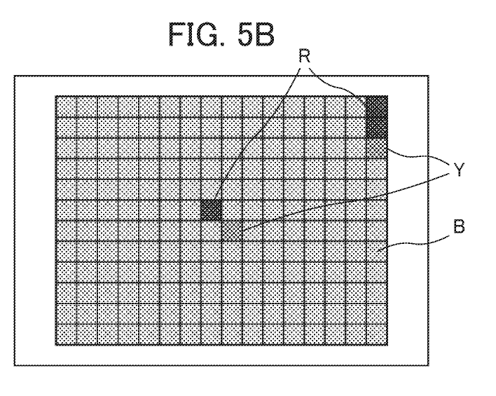

FIGS. 5A and 5B each show an exemplary screen display according to a method of inspecting the touch panel 702. The operator touches a start position (a small area at the upper left corner, for example) on the screen of FIG. 3 displayed in a matrix. This functions as a trigger to start inspection of the touch panel 702.

After the inspection is started, the screen shown in FIG. 5A is displayed, on which a guidance G with an arrow continues extending to point all the small areas in the matrix sequentially. The operator traces the touch panel 702 by following this guidance display. After a degree of deterioration in each small area is determined, the screen shown in FIG. 5B is displayed on which each small area is identified by a prescribed color. This example shows that small areas Y (yellow) are deteriorated and small areas R (red) are deteriorated more seriously. The other small areas B (blue) are available areas without any hindrance as these areas are free from deterioration, or with low degrees of deterioration.

The calculation unit 116 calculates a speed of movement of the touch position based on the touch position detected continuously by the detection unit 111, and time intervals between the detections. If the speed of movement of the touch position is to be controlled by the guidance unit 115, the calculation unit 116 is not required to calculate a speed of movement. Meanwhile, if the operator is allowed to perform touch operation freely, a speed of movement calculated by the calculation unit 116 is provided to the setting unit 112. Then, the setting unit 112 sets an expectation in each small area in response to the speed of movement.

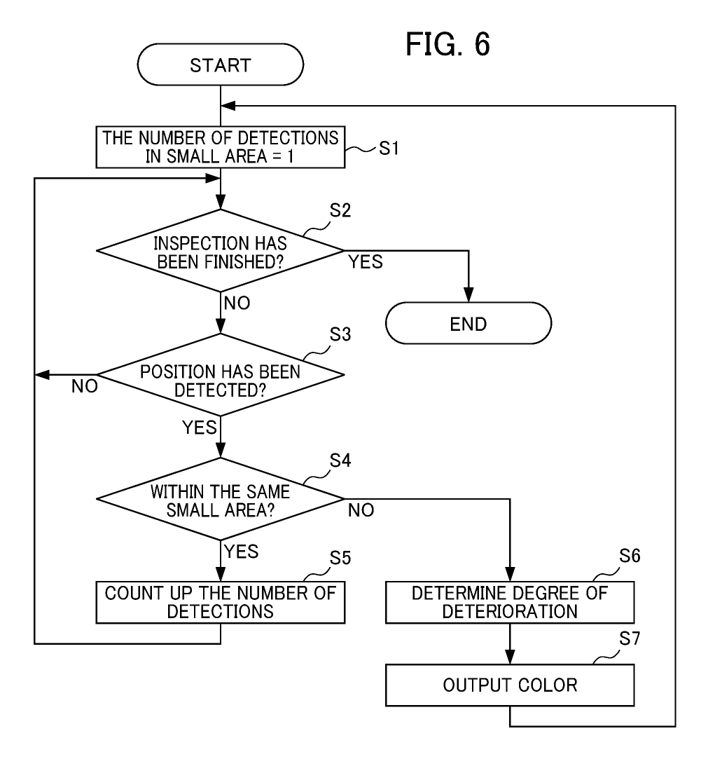

FIG. 6 is a flowchart showing processing executed by the CPU 11 according to the method of inspecting the touch panel 702. Execution of this processing is triggered by touch of a start position for the inspection by an operator.

In step S1, the CPU 11 (detection unit 111) sets the number of detections of touches in a small area including a detected touch position at 1.

In step S2, the CPU 11 determines whether or not an inspection period (period when a guidance display is provided by the guidance unit 115, for example) has elapsed. If YES, the processing is finished. If NO, the processing shifts to step S3.

In step S3, the CPU 11 (detection unit 111) tries to detect the touch position at a given frequency and determines whether or not the position has been detected. If YES, the processing shifts to step S4. If NO, the processing shifts to step S2.

In step S4, the CPU 11 (detection unit 111) determines whether or not the detected position is within a small area the same as the small area where the touch position was detected last time. If YES, the processing shifts to step S5. If NO, the processing shifts to step S6.

In step S5, the CPU 11 (detection unit 111) counts up the number of detections of touches in the small area in which the touch position is detected while the number of detections of the touch position is being counted in this small area. Then, the processing shifts to step S2.

In step S6, the CPU 11 (determination unit 113) determines a degree of deterioration of the touch panel 702 based on the number of detections in each small area from which the touch position has been moved and for which counting has been finished.

In step S7, the CPU 11 (output unit 114) outputs a color to a corresponding small area in the display 701 for color-coding this small area in response to the determined degree of deterioration. Then, the processing shifts to step S1.

The above-described processing flow is merely an example and is not the only procedure of determining a degree of deterioration based on the number of detections in each small area. The number of detections in each small area may be counted intermittently at given time intervals (intervals of 0.1 seconds, for example), on condition that an operator performs touch operation by following a guidance display.

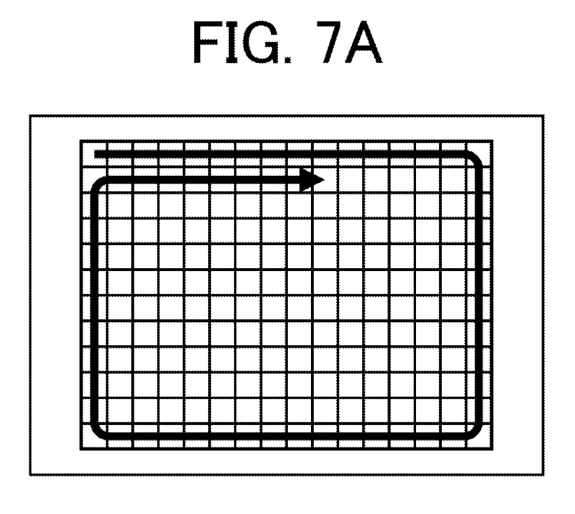

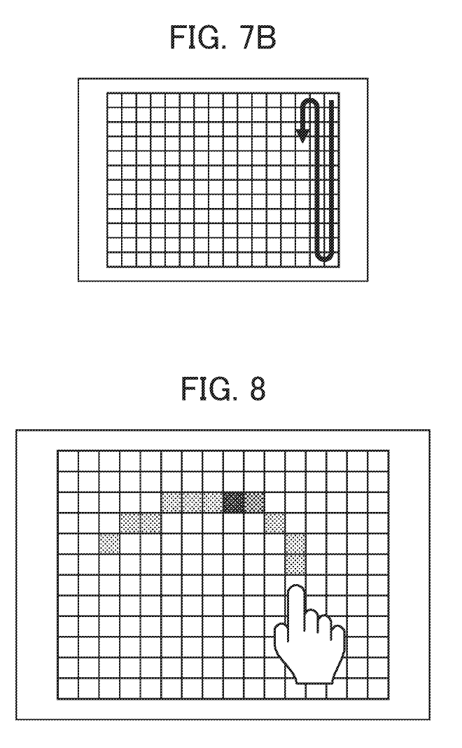

A guidance display is not limited to the shape and the order shown in FIG. 5A, but can be provided in various forms, as long as the guidance display is provided by a display method of moving between all small areas. FIGS. 7A and 7B each show an exemplary variation of a guidance display. As shown in FIG. 7A, for example, the guidance display may be provided by making a move on the display 701 in an outside-to-inside spiral pattern or an inside-to-outside spiral pattern. A start position of the guidance display is not limited to an upper left position. As shown in FIG. 7B, the guidance display may be started from a different position such as an upper right position.

Even in the absence of a guidance display, the numerical controller 1 is still allowed to set an expectation of the number of detections in each small area based on a speed of movement calculated by the calculation unit 116 and determine a degree of deterioration of the touch panel 702 in the above-described manner. FIG. 8 shows an exemplary screen display without a guidance display. Small areas after being inspected in terms of a degree of deterioration are changed in display colors so as to follow a path of touch operation by an operator. By tracing areas displayed in a color of an initial state, the operator is allowed to inspect the touch panel 702 entirely.

According to this embodiment, the numerical controller 1 sets an expectation of the number of detections in each of the small areas resulting from division of the display 701 in response to a speed of movement of the position of touch by an operator, and compares the number of detections with a threshold determined based on the expectation, thereby outputting a degree of deterioration in each small area in the touch panel 702. Thus, the numerical controller 1 can detect a degree of deterioration of each area in the touch panel 702 in advance by making an operator perform touch operation before operation on the touch panel 702 is hindered. As a result, action can be taken such as adjusting a display position of an icon of an application to prevent use of a deteriorated portion in the touch panel 702, for example.

The numerical controller 1 provides a guidance display for letting an operator touch multiple small areas continuously in a given order. This achieves efficient inspection of the touch panel 702 entirely. At this time, the numerical controller 1 can fix an expectation of the number of detections in each small area by moving the guidance display at a constant speed. Thus, processing efficiency is increased.

The numerical controller 1 can calculate a speed of movement based on a detected touch position and time intervals between the detections, and set an expectation of the number of detections in each small area. Thus, the numerical controller 1 increases the flexibility of touch operation during the inspection, thereby facilitating an operating procedure to be taken by an operator.

The numerical controller 1 displays a determination result about a degree of deterioration by color-coding each small area in response to the result. This allows an operator to easily understand an area with deterioration in the touch panel 702 and a level of the deterioration. Further, the operator is allowed to understand a transition of the deterioration of the touch panel 702 by using the above-described inspection method regularly. Thus, time of exchange of the touch panel 702 can be estimated. For this estimation, it is desirable that a degree of deterioration be categorized into finely graded levels.

Although an embodiment of the present invention has been described, the present invention is not to be limited to the above-described embodiment. The effects described in this embodiment are merely a list of most preferred effects resulting from the present invention. Effects achieved by the present invention are not to be limited to those described in this embodiment.

Color-coding showing a degree of deterioration of the touch panel 702 corresponding to a result of determination may be given after all areas are subject to the determination. Alternatively, color-coding of each small area may be timed to coincide with making a determination regarding this small area. A display showing boundaries between small areas (display in a matrix) may be omitted. The inspection may be started from a prescribed position (upper left corner, for example). Alternatively, it may be started from a position initially touched by an operator. According to this alternative, the guidance unit 115 sets a route for a guidance display to cover an entire area based on the start position.

The method of inspecting the touch panel 702 executed by the numerical controller 1 is realized by software. To realize the inspection method by software, programs constituting the software are installed on a computer (numerical controller 1). These programs may be stored in a removable medium and then distributed to a user. Alternatively, these programs may be distributed by being downloaded onto a computer of the user through a network.

### EXPLANATION OF REFERENCE NUMERALS

1 Numerical controller (display device)
11 CPU
111 Detection unit
112 Setting unit
113 Determination unit
114 Output unit
115 Guidance unit
116 Calculation unit
701 Display (display unit)
702 Touch panel

What is claimed is:

1. A display device comprising:
a detection unit that detects a touch position on a display unit at a given frequency;
a setting unit that sets an expectation of the number of detections by the detection unit in each of the small areas resulting from division of the display unit in response to a speed of movement of the touch position;
a determination unit that determines a degree of deterioration of each of the small areas by comparing the number of detections by the detection unit with one or more thresholds determined based on the expectation; and
an output unit that outputs the degree of deterioration.

2. The display device according to claim 1, comprising a guidance unit that provides a guidance display for letting the small areas be touched continuously in a given order.

3. The display device according to claim 2, wherein the guidance unit provides a display for moving between the small areas at a predetermined constant speed.

4. The display device according to claim 1, comprising a calculation unit that calculates the speed of movement based on the touch position detected continuously, and time intervals between the detections.

5. The display device according to claim 1, wherein the output unit color-codes each of the small areas in response to the degree of deterioration based on a result of the determination by the determination unit.

6. An inspection method to be executed by a computer, the method comprising:
a detecting step of detecting a touch position on a display unit at a given frequency;
a setting step of setting an expectation of the number of detections by the detecting step in each of the small areas resulting from division of the display unit in response to a speed of movement of the touch position;
a determining step of determining a degree of deterioration of each of the small areas by comparing the number of detections by the detecting step with one or more thresholds determined based on the expectation; and
an outputting step of outputting the degree of deterioration.

7. A non-transitory computer-readable medium storing an inspection program that causes a computer to execute:
a detecting step of detecting a touch position on a display unit at a given frequency;
a setting step of setting an expectation of the number of detections by the detecting step in each of the small areas resulting from division of the display unit in response to a speed of movement of the touch position;
a determining step of determining a degree of deterioration of each of the small areas by comparing the number of detections by the detecting step with one or more thresholds determined based on the expectation; and
an outputting step of outputting the degree of deterioration.
